(19) United States
(12) Patent Application Publication
(10) Pub. No.: US 2014/0122646 A1
(43) Pub. Date: May 1, 2014

(54) METHOD FOR MANAGING DATA AND ELECTRONIC DEVICE FOR PROCESSING METHOD

(71) Applicant: Samsung Electronics Co., Ltd., Gyeonggi-do (KR)

(72) Inventor: Jang-Hoon Lee, Gyeongsangbuk-do (KR)

(73) Assignee: Samsung Electronics Co., Ltd., Gyeonggi-do (KR)

(21) Appl. No.: 14/063,677

(22) Filed: Oct. 25, 2013

(30) Foreign Application Priority Data
Oct. 25, 2012 (KR) 10-2012-0118963

(51) Int. Cl. H04L 29/08

(52) U.S. Cl. CPC H04L 67/10
USPC 709/217

(57) ABSTRACT

An apparatus and a method for managing data in an electronic device are provided. The method includes marking user information onto data and storing the marked data; determining marked data to transmit from among data stored in advance, the data stored in advance including the stored marked data; extracting user information from the determined marked data; and setting the extracted user information as reception-side information of the determined marked data and transmitting the determined marked data according to the set reception-side information.

### PRIORITY

This application claims priority under 35 U.S.C. §119(a) to a Korean patent application filed in the Korean Intellectual Property Office on Oct. 25, 2012 and assigned Serial No. 10-2012-0118963, the entire content of which is incorporated herein by reference.

### BACKGROUND OF THE INVENTION

1. Field of the Invention

The present invention relates generally to an apparatus and a method for managing data in an electronic device, and more specifically, to an apparatus and method for determining data to be transmitted.

2. Description of the Related Art

Recently, due to the rapid development of electronic devices, electronic devices enabling wireless voice communication and information exchange have become a daily necessity. In an early stage of distribution of electronic devices, electronic devices have merely been used as portable devices that enable wireless communication, but as electronic device technology develops and a wireless Internet is introduced into more electronic devices, electronic devices are no longer merely used for the purpose of simple telephone communication and schedule management, but have attained an expanded utilization range to other functions, such as games, a remote controller using short distance communication, and capturing an image using a built-in digital camera, meeting a user's need.

These newer electronic devices with an expanded utilization range may generate and store a plurality of data. For example, an electronic device may generate and store photographed image data, and generate and store save data with a game executed.

An electronic device may also reproduce the data via a screen according to a user's request. Accordingly, recently, an interest in developing electronic devices having touchscreens, while increasing the size of display units in such devices by improving space utilization increases.

A touchscreen is a combination of an input and display unit for performing input and display of information on one screen. Accordingly, when using the touchscreen, an electronic device has an increased display area relative to other devices having a separate input unit, such as a keypad. For example, when using a full touch type, where the touchscreen is applied to an entire screen, the front side of the electronic device is utilized as a screen, and therefore a screen size is extended relative to other devices without a touchscreen.

Electronic device are also capable of transmitting data to other users.

Generally, an electronic device transmits data to other users using a transmission program.

More specifically, a user of an electronic device, who intends to transmit data, executes a transmission program, such as a message program, an e-mail program, a messenger program, etc., to select data to transmit, and inputs information of a user corresponding to a reception-side, and then attaches data and transmits the same.

An electronic device may receive data to transmit and information of a reception-side user, in order to transmit data to the reception-side user.

However, to transmit a plurality of data, a user must repeatedly perform a process of transmitting a single data item, and then subsequently transmitting another data item.

That is, conventional data transmission methods permit a user to transmit only one data item at a time, and a user may only select data to transmit while a transmission program is being executed.

### SUMMARY OF THE INVENTION

An aspect of the present invention is to address at least the above-mentioned problems and/or disadvantages and to provide at least the advantages described below.

Another aspect of the present invention is to provide an apparatus and a method for managing data using user information in an electronic device.

Another aspect of the present invention is to provide an apparatus and a method for transmitting data on which user information has been marked in an electronic device.

Another aspect of the present invention is to provide an apparatus and a method for marking user information and information regarding a transmission program on data in an electronic device.

Another aspect of the present invention is to provide an apparatus and a method for using marked user information as reception-side information when transmitting data in an electronic device.

In accordance with an aspect of the present invention, a method for managing data in an electronic device is provided. The method includes marking user information onto data and storing the marked data; determining marked data to transmit from among data stored in advance, the data stored in advance including the stored marked data; extracting user information from the determined marked data; and setting the extracted user information as reception-side information of the determined marked data and transmitting the determined marked data according to the set reception-side information.

In accordance with another aspect of the present invention, an electronic device is provided. The electronic device includes a display; and at least one processor, wherein the processor marks user information onto data and stores the marked data, determines marked data to transmit from among data stored in advance, the data stored in advance including the stored marked data, extracts user information from the determined marked data, sets the extracted user information as reception-side information of the determined marked data, control transmission of the determined marked data according to the set reception-side information.

In accordance with another aspect of the present invention, a non-transitory computer-readable storage medium that records a program thereon is provided. When executed by an electronic device, the program allows the electronic device to mark user information onto data and store the marked data, determine marked data to transmit from among data stored in advance including the stored marked data, extract user information from the determined marked data, and set the extracted user information as reception-side information of the determined marked data for transmission of the determined marked data.

### BRIEF DESCRIPTION OF THE DRAWINGS

The above and other aspects, features and advantages of certain embodiments of the present invention will be more apparent from the following description taken in conjunction with the accompanying drawings in which:

FIG. 1 is a block diagram illustrating an electronic device for marking user information on data and managing the data according to an embodiment of the present invention;

FIG. 2 is a flowchart illustrating a process for marking user information on data in an electronic device according to the present invention;

FIG. 3 is a flowchart illustrating a process for transmitting data using marked user information in an electronic device according to the present invention;

FIG. 4 is a flowchart illustrating a process for transmitting data using marked user information in an electronic device according to another embodiment of the present invention;

FIGS. 5A to 5D are diagrams illustrating examples of screens in a process for marking user information on data in an electronic device according to an embodiment of the present invention;

FIGS. 6A to 6D are diagrams illustrating examples of screens in a process for transmitting data in an electronic device according to an embodiment of the present invention;

FIGS. 7A to 7C are diagrams illustrating examples of screens in a process for marking user information on data in an electronic device according to another embodiment of the present invention;

FIG. 8 is a diagram illustrating an example of a screen in a process for generating data onto which user information has been marked in an electronic device according to an embodiment of the present invention;

FIGS. 9A to 9B are diagrams illustrating examples of screens in a process for transmitting data in an electronic device according to another embodiment of the present invention;

FIGS. 10A to 10B are diagrams illustrating examples of screens in a process for transmitting data in an electronic device according to still another embodiment of the present invention; and

FIGS. 11A to 11D are diagrams illustrating examples of screens in a process for receiving data on which user information has been marked to update phonebook data in an electronic device according to an embodiment of the present invention.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. Throughout the drawings, like reference numerals may be used to refer to like parts, components and structures. The following description includes various specific details to assist in that understanding but these are to be regarded as mere examples. Accordingly, various changes and modifications of the embodiments described herein can be made without departing from the scope and spirit of the invention. Also, descriptions of well-known functions and constructions may be omitted for clarity and conciseness.

The terms and words used in the following description and claims are not limited to the bibliographical meanings, but are merely used to enable a clear and consistent understanding of the invention. Accordingly, the following description of embodiments of the present invention is merely provided for illustration purposes, and do not limit the scope of the invention as defined by the appended claims and their equivalents.

Embodiments of the present invention provide an apparatus and a method for marking user information on data, in order to manage the data, and using marked user information as reception-side information during data transmission in an electronic device.

Herein, the user information marked on the data refers to an identifier of a counterpart user to which data is to be transmitted, and this user information may be input information included in phonebook data. Additional information, such as an e-mail address, messenger information, etc., may be set to phonebook data by a user, so that the phonebook data may be used as user information marked on data.

For example, marking phonebook data of a user A on specific data may include denoting, as marked data, all information (e.g., a phone number, an e-mail address, messenger information, etc.) corresponding to the user A and set in advance in phonebook data.

In addition, the electronic device may mark one or more information items corresponding to a user on data. More specifically, the electronic device may mark only an e-mail address of the user A on data, or the electronic device may additionally mark messenger information of the user A together with the e-mail address. When transmitting data on which a plurality of information items have been marked, the electronic device may allow a user to select at least one transmission program (e.g., a messenger program, a short message transmission program, an e-mail program, etc.) and transmit relevant data through the selected at least one transmission program.

The electronic device may mark information corresponding to a plurality of users on one data item. In this case, the electronic device may allow a user to select at least one user and transmit relevant data to the at least one selected user.

The electronic device may detect a user's gesture and perform the above-mentioned operation in response to the detected gesture. Herein, a gesture refers to a touch pattern formed on the touchscreen of the electronic device. A touch is performed on the touchscreen of the electronic device by an input unit on the exterior of the electronic device. Examples of an input unit include a user's finger, a stylus pen, etc. More specifically, the gesture may be in the form of a drag of a predetermined pattern performed with a touch maintained on the touchscreen. The gesture may also include not only a drag, but also include a release of a previously-maintained touch.

For example, with information regarding data displayed, a user may generate a gesture to display user information, and mark the user information on relevant data using another gesture.

An electronic device according to embodiments of the preset invention may be a portable electronic device, such as a portable terminal, a mobile phone, a media player, a tablet computer, a handheld computer, or a Personal Digital Assistant (PDA). Such an electronic device may also be an arbitrary portable electronic device that combines two or more functions among these devices.

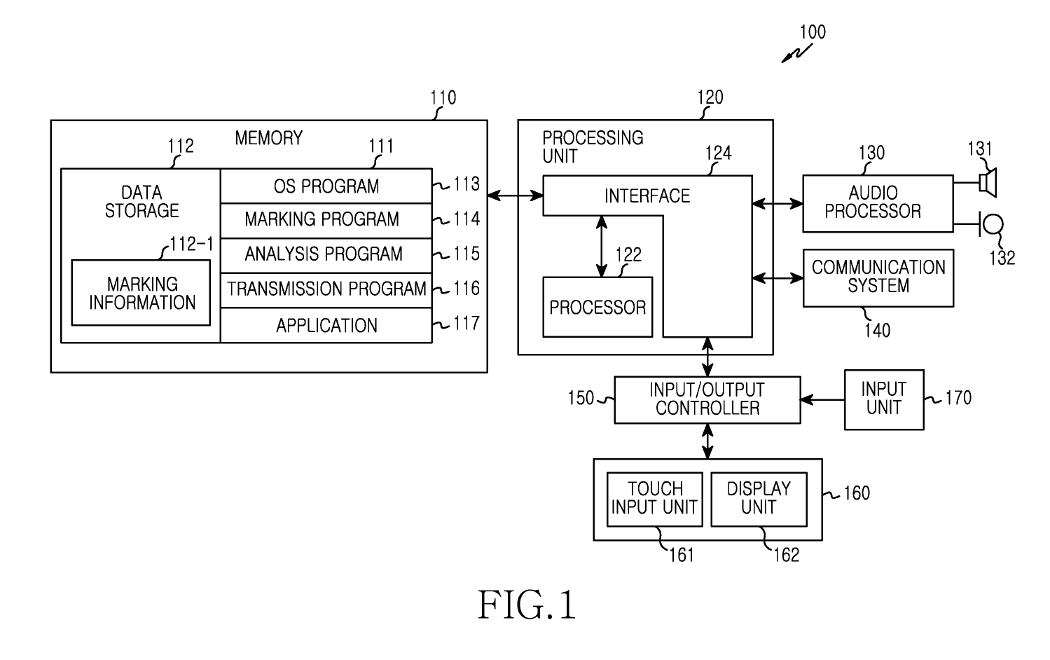

FIG. 1 is a block diagram illustrating an electronic device for marking user information on data and managing the data according to an embodiment of the present invention.

Referring to FIG. 1, an electronic device 100 includes a memory 110, a processor unit 120, an audio processor 130, a communication system 140, an input/output controller 150, a touchscreen 160, and an input unit 170. Although not shown, a plurality of any of the above-mentioned elements may be provided in the electronic device 100 in accordance with embodiments of the present invention. For example, the electronic device 100 may include a plurality of memories 110 and a plurality of communication systems 140.

The memory 110 includes a program storage 111 for storing a program for controlling an operation of the electronic device 100, and a data storage 112 for storing data generated during execution of a program. For example, the data storage 112 may store various updatable data for storage such as a phonebook, calling messages, received messages, and store marking information 112-1 according to the present invention. The marking information 112-1 is user information marked-on data, or information regarding data on which user information is marked. More specifically, the electronic device 100 is able to manage user information marked for each data or manage data marked for each user.

The data storage 112 stores information regarding a program transmitting data upon which user information has been marked.

In addition, the data storage 112 may store a user's gesture for marking user information onto the data, and a user's gesture (gesture information) for transmitting the data to the marked user.

The program storage 111 may include an Operating System (OS) program 113, a marking program 114, an analysis program 115, a transmission program 116, and at least one application 117. Programs are stored in the program storage 111 as a set of instructions, and may be expressed as an instruction set.

The OS program 113 includes various software elements for controlling a general system operation of the electronic device 100. Control of the general system operation includes memory management and control, storage hardware (device) control and management, power control and management, etc. The OS program 113 may also perform a function for swift communication between various hardware devices and program elements (i.e., program modules).

The marking program 114 includes various software elements for performing a marking process for marking user information on data.

The marking program 114 marks information of a reception-side user who receives relevant data and transmission information regarding specific data selected by a user.

Here, the user information is identifying information of a counterpart user and may include a counterpart user's name, phone number, etc. The transmission information indicates a method for transmitting data to a counterpart user and may be data transmission using an e-mail, data transmission using a message, data transmission using a messenger, data transmission using a fax, etc.

In addition, the marking program 114 may perform a marking process on data stored in advance. Furthermore, the marking program 114 may perform a marking process on data newly-generated by the electronic device 100. Here, the data stored in advance may include image data stored in a gallery, memo data, media data, etc. The newly-generated data may be image data newly stored using a camera function, and data received from other users, for example.

In addition, the marking program 114 may perform the marking process by generating information defining user information for each data and managing the information in the form of a table.

In addition, the marking program 114 may perform the marking process by writing in user information and a transmission method on the header or meta information of data selected by a user.

The analysis program 115 includes various software elements for analyzing information of a reception-side user and transmission information marked on data stored in the electronic device 100.

More specifically, the analysis program 115 analyzes data selected for data transmission by a user, analyzes information of a reception-side user and transmission information, and allows the analyzed information to be used as reception-side information during data transmission.

In addition, the analysis program 115 may determine data on which information of a counterpart user has been marked, by using an identifier of the counterpart user performing a messenger service communication and voice communication.

In addition, the analysis program 115 determines data on which transmission information corresponding to an executed transmission program has been marked. When at least one transmission program is executed, the analysis program 115 allows data marked by the executed transmission program to be transmitted. For example, when an e-mail program is executed, the analysis program 115 may determine data onto which information allowing transmission via the e-mail program is marked.

The analysis program 115 analyzes information defining user information corresponding to each data item to determine information of a reception-side user marked onto data and transmission information.

For another example, the analysis program 115 may perform the marking process by determining the header or meta information of data selected by a user and writing-in user information and a transmission method.

The transmission program 116 includes various software programs for processing transmission of data selected by a user.

The transmission program 116 also sets user information determined by the analysis program 115 as reception-side information and transmit data selected by a user.

The transmission program 116 may be an e-mail program, a messenger program, a message transmission program, etc. According to an alternative embodiment of the present invention, the transmission program 116 may be included in the application 117.

The transmission program 116 may also process transmission of information marked onto data to a counterpart user when transmitting the data according to a user's request. For example, the information marked onto data may include user information and a message for counterpart user.

The application 117 may include a software element corresponding to at least one application installed in the electronic device 100.

A program included in the program storage 111 may be allowed to operate via a hardware configuration. According to an embodiment of the present invention, the electronic device 100 may include a marking module, an analysis module, a transmission module, etc. (not shown).

The processor unit 120 includes at least one processor 122 and an interface 124. Here, the processor 122 and the interface 124 may be integrated in at least one integrated circuit or realized as separate elements.

The interface 124 serves as a memory interface for controlling an access to the processor 122 and the memory 110.

In addition, the interface 124 serves as a peripheral interface for controlling a connection between an input/output peripheral of the electronic device and the processor 122.

The processor 122 controls the electronic device 100 to display a category using at least one software. At this point, the processor 122 controls execution of at least one program stored in the memory 110 and performs a function corresponding to the relevant program. For example, the processor 122 may include a marking processor for marking user information on data, analyzing marked information from data, and processing to transmit data using the analyzed information. This marking processor may perform the functions of the marking program 114, the analysis program 115, and the transmission program 116.

Accordingly, the marking process of the electronic device 100 may be performed using software, such as a program stored in the memory 110 or a hardware such as the display processor.

The audio processor 130 provides an audio interface between a user and the electronic device 100 via a speaker 131 and a microphone 132.

The communication system 140 performs a communication function for voice communication and data communication of the electronic device 100. The communication system may be divided into a plurality of communication submodules supporting different communication networks. The communication network may include, for example, a Global System for Mobile Communication (GSM) network, an Enhanced Data GSM Environment (EDGE) network, a Code Division Multiple Access (CDMA) network, a Wideband (W)-CDMA network, a Long Term Evolution (LTE) network, an Orthogonal Frequency Division Multiple Access (OFDMA) network, a wireless Local Area Network (LAN), a Bluetooth network, a Near Field Communication (NFC), etc. According to embodiments of the present invention, the communication system 140 transmits, to a counterpart user, data onto which user information has been marked, marked information, etc.

The input/output controller 150 may provide an interface between an input/output unit such as a touchscreen 160 and an input unit 170, and the interface 124.

The touchscreen 160 is an input/output unit performing input and output of information, and includes a touch input unit 161 and a display unit 162.

The touch input unit 161 provides touch information detected via a touch panel to the processor unit 120 via the input/output controller 150. The touch input unit 161 changes touch information into an instruction structure such as touchdown, touch move, and touch up (which may be alternatively be called touch, drag and release, respectively), and provides the information structure to the processor unit 120. According to an embodiment of the present invention, the touch input unit 161 may generate a user's gesture for executing a marking process, and input information to mark to data.

The display unit 162 displays state information of the electronic device 100, characters input by a user, moving pictures, still pictures, etc. For example, the display unit 162 displays a marking process and displays a process of marking user information onto data and displays information marked on data.

The input unit 170 provides input data generated by a user's selection to the processor unit 120 via the input/output controller 150. For example, the input unit 170 may include only a control button for controlling the electronic device 100. According to another example, the input unit 170 may be configured using a keypad for receiving input data from a user. According to an embodiment of the present invention, the input unit 170 generates a user's input for executing a marking process, and inputs information to mark to data.

Although not shown, the electronic device 100 may further include elements for providing an additional function, such as a camera module for photographing an image or a moving picture, a broadcast reception module for receiving broadcasting, a digital sound source reproduce module such as an Moving Picture Experts Group (MPEG) Audio-Layer-3 (MP3) module, a short distance wireless communication module for short distance wireless communication, and a proximity sensor module for proximity sensing, etc., and software for operating these modules.

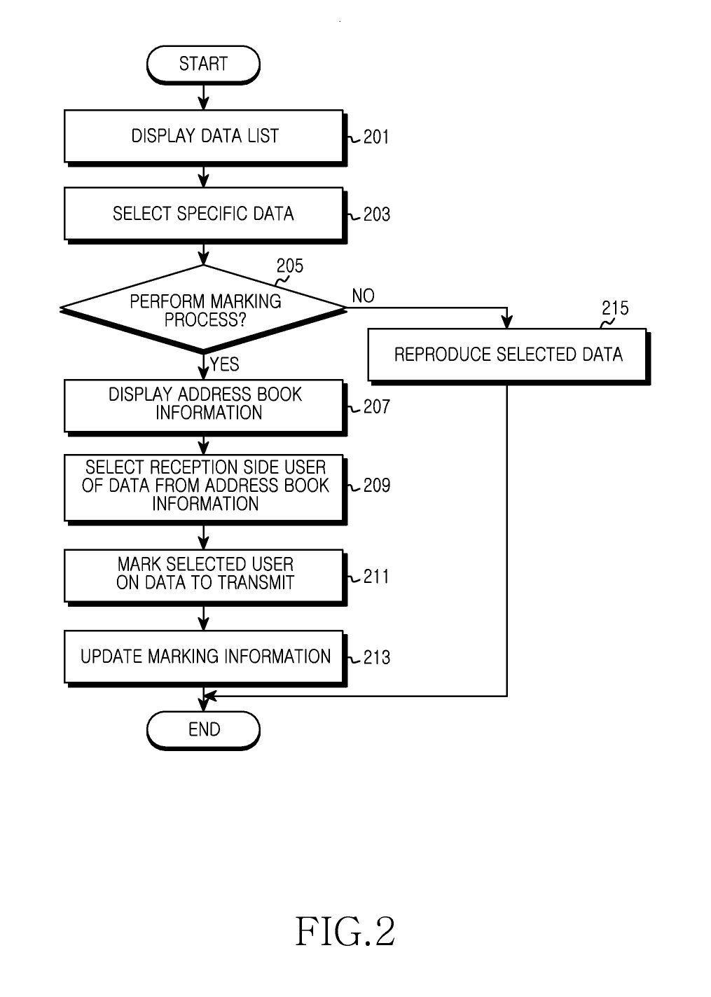

FIG. 2 is a flowchart illustrating a process for marking user information onto data in an electronic device according to an embodiment of the present invention.

Referring to FIG. 2, the electronic device displays a list of data stored in advance in step 201, and then proceeds to step 203 to determine whether specific data is selected by a user.

After step 203, the electronic device proceeds to step 205 to determine whether to perform a marking process. Here, the marking process includes setting information of a reception-side user who receives relevant data and transmission information to specific data selected by a user. Here, the user information is identifying information of a counterpart user (i.e., the reception-side user), and the user information may include the counterpart user's name, phone number, etc. The transmission information indicates a method for transmitting data to a counterpart user, and the transmission information may indicate data transmission using an e-mail, data transmission using a message, data transmission using a messenger, data transmission using a fax, etc.

In response to a determination that a marking process will not be performed, the electronic device proceeds to step 215 to reproduce data selected by a user. Herein, reproducing the data refers to performing a specific operation with respect to the selected data. For example, when the selected data is image data, the electronic device may execute an image viewer to display the image data.

In response to a determination to perform a marking process, the electronic device proceeds to step 207 to display user information that may be usable as an identifier of a counterpart user, and then proceeds to step 209 to allow a user to select a reception-side user of data among the displayed information. Herein, according to an embodiment of the present invention, the electronic device may display phonebook data to allow the user to select a reception-side user. Since additional information such as an e-mail address, messenger information, fax information, etc. is set in the phonebook data, the electronic device may use user information stored in the phonebook data as an identifier of a counterpart user.

When selecting a counterpart user using the phonebook data, the electronic device may use, not only a phone number of the phonebook data, but also additional information (e.g., an e-mail address, messenger information, etc.) as a data transmission method.

In this case, the selected data may be transmitted to a counterpart user according to only information set to the phonebook data. For example, a counterpart user to whom only an e-mail has been set may receive specific data via only the set e-mail.

According to another embodiment of the present invention, when specific data is selected by a user, the electronic device may display a screen for receiving user information to allow a user to input user information to mark in person. According to an embodiment of the present invention, the electronic device may allow the user to input user information and a transmission method via the displayed screen.

After performing step 209, the electronic device proceeds to step 211 to perform a marking process on the selected data, and then proceeds to step 213 to update marking information. Here, performing the marking process includes setting user information and a transmission method to the selected data. For example, the electronic device generates information defining user information for each data and manages the information in the form of a table.

For another example, a user may write in user information and a transmission method on the header or meta information of data selected by the user.

After performing the marking process, the electronic device ends the present algorithm for marking user information on data.

Although the above description refers to a marking process for data stored in advance with reference to the drawing, a marking process according to an embodiment of the present invention may be performed at a time when new data is generated in the electronic device. For example, the electronic device may perform the marking process at a time when a camera function is executed and then input of a shooting button is detected and image data is obtained.

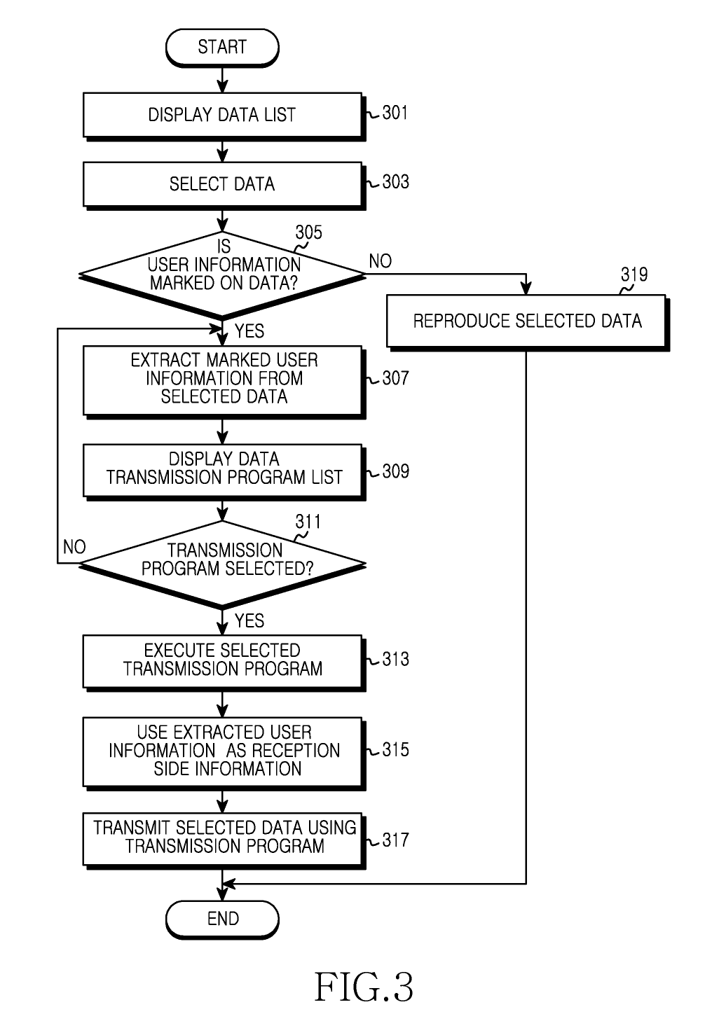

FIG. 3 is a flowchart illustrating a process for transmitting data using marked user information in an electronic device according to an embodiment of the present invention.

Referring to FIG. 3, the electronic device displays a data list in step 301, and then proceeds to step 303 to determine data selected for transmission to another user. According to an embodiment of the present invention, the electronic device may transmit the user-selected data by using user information marked onto the data as reception-side information. According to an embodiment of the present invention, a data list displayed on the electronic device may be a list of data stored in the electronic device, regardless of whether user information is marked. The electronic device may classify only data onto which user information has been marked, make a list according to the classification, and display the list. In addition, the electronic device may detect a user's gesture to determine selected data.

After step 303, the electronic device proceeds to step 305 to determine whether user information has been marked onto the data selected by the user.

At step 305, since the electronic device generates information defining user information for each data and manages the information in the form of a table, the electronic device determines whether the user information has been marked onto the data selected by the user.

In another method according to an embodiment of the present invention, since the electronic device writes in user information, a transmission method, etc. on the header or meta information of the data selected by the user, the electronic device determines whether the user information has been marked by determining the header or meta information of the data selected by the user.

In response to a determination that the user information has not been marked on the data selected by the user, the electronic device proceeds to step 319 to process reproduction of the data selected by the user. Reproduction of the data includes performing a peculiar operation on the selected data. For example, when the selected data is image data, the electronic device executes an image viewer to display the image data.

In response to a determination that the user information has been marked on the selected data, the electronic device proceeds to step 307 to extract the marked user information from the selected data.

More specifically, the electronic device extracts information of a reception-side user to whom the data selected by the user is to be transmitted.

A transmission method for a plurality of users may be marked on the data. For example, information of a user A and a user B may be marked on the data.

In order to determine a user to whom the selected data is to be transmitted, the electronic device displays a list of users marked on the selected data and then allows the user to select a counterpart user to whom the data is to be transmitted.

After extracting the information of the reception-side user, the electronic device proceeds to step 309 to display a data transmission program list. Here, the data transmission program is used during data transmission. The transmission program is determined by a transmission method marked onto data. For example, when the marked transmission method is a phone number of a reception-side user, the transmission program may be a short message program. Also, when the marked user information is messenger information of a reception-side user, the transmission program may be a messenger program. In addition, when the marked user information is e-mail information of a reception-side user, the transmission program may be an e-mail program.

According to an embodiment of the present invention, a plurality of transmission methods may be marked on the data with respect to one user, so that the electronic device may display a list of data transmission programs to determine selection of a transmission program for a transmission method.

For example, when information of a user C formed of a phone number and e-mail information is marked on the data, the electronic device displays a list of an e-mail program and a message program.

When only one transmission method is marked on the data, the above-described process of displaying a list of data transmission programs may be omitted.

After displaying the transmission program list, the electronic device proceeds to step 311 to determine whether a transmission program is selected by a user.

In response to a determination that a transmission program is not selected, the electronic device returns to step 309 to continue displaying the transmission program list.

In response to a determination that a transmission program is selected, the electronic device proceeds to step 313 to execute the transmission program selected by the user, and then proceeds to step 315 to use the extracted user information as reception-side information of the transmission program, and then proceeds to step 317 to process transmission of the selected data using the transmission program.

After transmitting the selected data using the transmission program, the electronic device ends the above-described algorithm.

After transmitting data, the electronic device may delete the user information marked onto the data. Here, deletion of the marked user information may include deleting information of transmitted data from information defining address book information for each data or deleting address book information from the header or meta information of the data selected by the user.

According to another embodiment of the present invention, the electronic device may transmit marking information together to a reception-side when transmitting data. According to an embodiment of the present invention, a user who receives data may add user information included in marking information to phonebook data of the user.

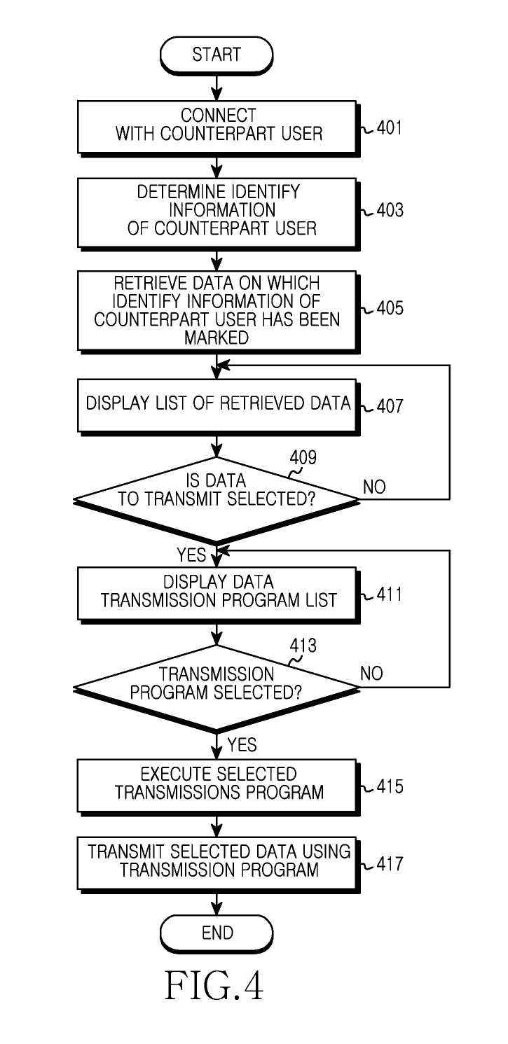

FIG. 4 is a flowchart illustrating a process for transmitting data using marked user information in an electronic device according to another embodiment of the present invention.

Referring to FIG. 4, the electronic device performs connection with a counterpart user, in step 401. Step 401 may include performing communication connection with a counterpart user, a process for having a conversation via a messenger, a process for making an e-mail to a counterpart user, etc.

After step 401, the electronic device proceeds to step 403 to determine identifying information such as a phone number, a name, a messenger IDentification (ID), an e-mail address, etc. of a counterpart user, and then proceeds to step 405 to retrieve data on which identifying information of the counterpart user has been marked. In performing this determination, the electronic device determines whether data (i.e., data on which counterpart user information has been marked) that may be transmitted to the counterpart user who is currently connected for communication exists among data stored in advance.

After step 405, the electronic device proceeds to step 407 to display a list of retrieved data, and then proceeds to step 409 to determine whether a user selects data to transmit.

In response to a determination that data to transmit has not been selected in step 409, the electronic device returns to step 407 and continues to display the list of retrieved data.

However, when data to transmit is selected in step 409, the electronic device proceeds to step 411 to display a data transmission program list, and then proceeds to step 413 to determine a transmission program selected by a user. The electronic device may transmit selected data in the form of an attached file according to a communication scheme currently connected with a user, but since the electronic device may transmit data via a transmission program regardless of the current communication scheme, the electronic device displays a transmission program list. Of course, the electronic device may display the transmission program list using a predetermined transmission method of a user.

In response to a determination that a transmission program has not been selected by a user, the electronic device returns to step 411 and continues displaying the transmission program list.

However, upon a determination that a transmission program is selected by the user, the electronic device proceeds to step 415 to execute the transmission program selected by the user, and then proceeds to step 417 to process to transmission of the selected data using the transmission program.

When data is selected by a user, the electronic device transmits the data using the transmissions program in FIG. 4, a charge may occur depending on data transmission. According to an embodiment of the present invention, the electronic device may store data to transmit and information regarding a transmission program, and then transmit relevant data at a point where the electronic device is positioned in an area (e.g., a Wi-Fi available area) where charges is not generated, thereby preventing charge generation.

After transmission of the data in step 417, the electronic device ends the present algorithm.

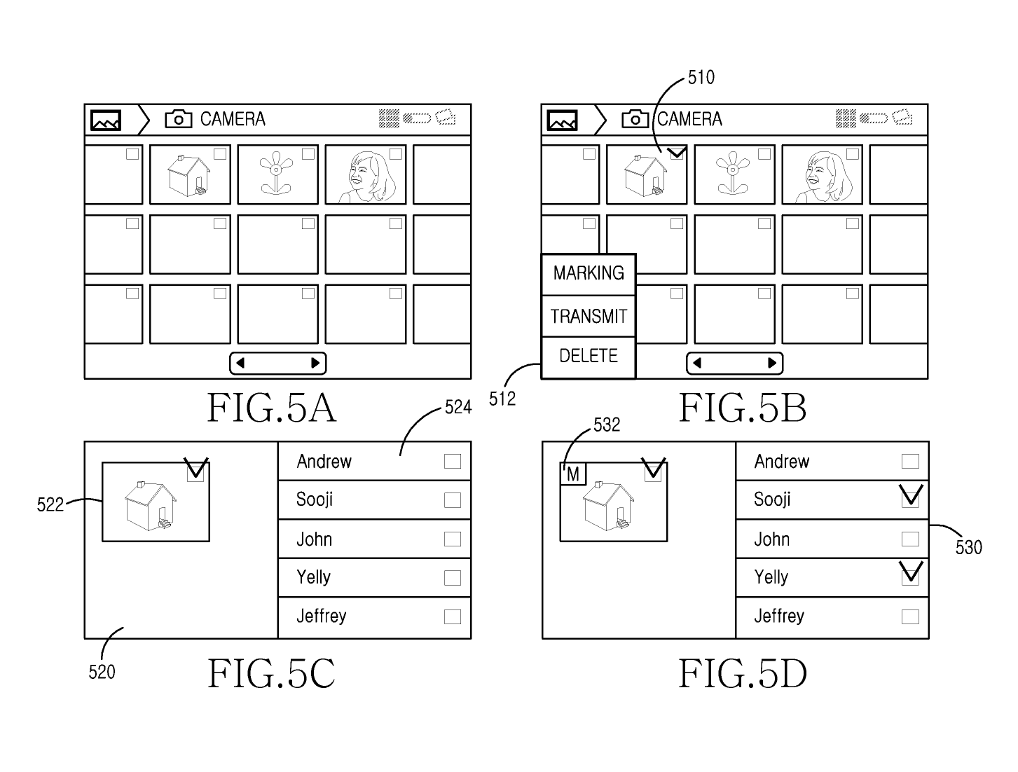

FIGS. 5A to 5D are diagrams illustrating examples of screens in a process for marking user information on data in an electronic device according to an embodiment of the present invention.

Referring to FIG. 5A, first, the electronic device displays a data list in order to mark user information onto data. For example, the electronic device may execute a gallery to display a list of image data stored in the electronic device.

Generally, the gallery includes a selection region 503 in which image data may be selected, and a specific effect is applied to the selection region of image data selected by a user.

In addition, an edit process 512 may be performed on the image data 510 selected by the user as illustrated in FIG. 5B, and according to an embodiment of the present invention, a marking process is performed. The edit process includes, for example, transmission of selected image data to a specific user via a message or deleting the selected image data from the gallery.

When performing a marking process on the selected image data, the electronic device displays a marking process screen 520, as illustrated in FIG. 5C.

The marking process screen 520 includes data (i.e., image data) 522 selected by a user and user information 524. The selected data 522 is an object of a marking process, and the user information 524 includes identifying information of a reception-side user who receives the selected data. According to an embodiment of the present invention, information included in the phonebook data may be used as the user information.

FIGS. 5C to 5D depict users Andrew, Sooji, John, Yelly, and Jeffrey included in phonebook data that are provided as user information. The user information may not all be simultaneously displayed on a limited screen. In this case, though not shown, other user information may be displayed in response to a user's input gesture.

The marking process includes marking user information onto specific data. As illustrated in FIG. 5D, when a user to mark is selected from among the displayed user information as indicated by reference numeral 530, the selected user information may be marked on selection data, which is an object of the marking process.

The selection data may include information 532 indicating that user information has been marked.

In addition, since additional information such as an e-mail address and a messenger ID as well as a phone number may be written in as user information of the phonebook data, written all information may be marked on data. Accordingly, data on which the user information has been marked may be transmitted to a counterpart user via an e-mail, a messenger, etc. as well as a marked phone number.

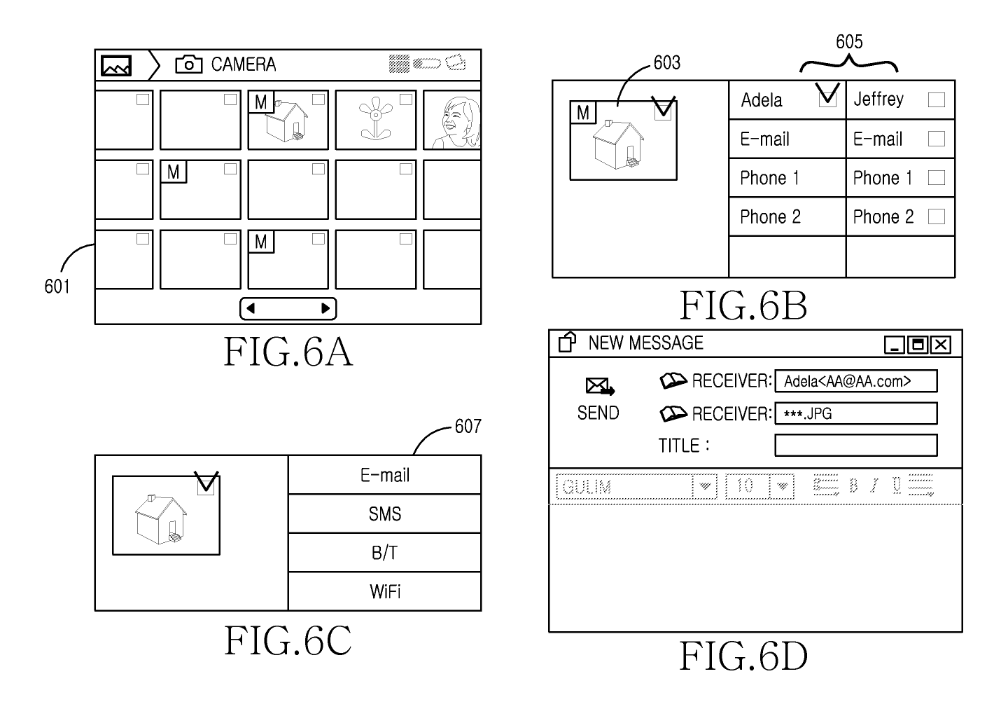

FIGS. 6A to 6D are diagrams illustrating screens in a process for transmitting data in an electronic device according to an embodiment of the present invention.

Referring to FIG. 6, at first, the electronic device displays a data list. For example, the electronic device executes a gallery to display a list 601 of image data stored in the electronic device. In the present example, image data on which user information has been marked and image data on which user information has not been marked are displayed together. A mark “M” of the image data indicates that user information has been marked.

When data on which user information has been marked is selected by a user while a data list displayed, the electronic device displays information 605 of a user marked on the selected data 603, as illustrated in FIG. 6B. FIG. 6B illustrates a situation where a list of users Adela and Jeffrey marked onto selected data is displayed.

A user marked onto the selected data is a user who may be reception-side information of the data.

Accordingly, a user of the electronic device will select a counterpart user to whom the selected data is to be transmitted among the displayed list.

When the user of the electronic device selects a counterpart user from the displayed list, the electronic device displays a transmission method 607 of the selected data, as illustrated in FIG. 6C.

FIG. 6C illustrates the electronic device may transmit the selected data to a counterpart user using an e-mail, a Short Message Service (SMS) message, Bluetooth, and WiFi. This transmission method is set via a marking process. When data is selected, the electronic device may determine a method for transmitting data to a counterpart user.

When a user of the electronic device selects an e-mail method from among the displayed transmission methods, the electronic device executes an e-mail program and then adds user information for the transmission method to reception-side information to enable data transmission, as illustrated in FIG. 6D.

More specifically, in the present example of FIG. 6D, an e-mail address of a selected user is added to receiver information, and selected data is added as an attached file.

When an SMS is selected from among the transmission methods displayed in FIG. 6C, the electronic device executes a short message program, and then adds a phone number of a user to reception-side information, and adds selected data as an attached file.

In addition, when Bluetooth is selected from among the transmission methods displayed in FIG. 6C, the electronic device retrieves a device of a user Adela among Bluetooth devices existing in the neighborhood and transmits selected data.

In addition, when WiFi is selected from among the transmission methods displayed in FIG. 6C, the electronic device retrieves a device of a user Adela among devices existing in the neighborhood and transmits selected data.

Although, in the example of FIGS. 6A to 6D information of a reception-side user and a data transmission method are marked onto data, according to an alternative embodiment of the present invention, a user may mark only information of a reception-side user without marking a transmission method.

When the user does not mark the transmission method, the data is transmitted via one of data transmission methods supported by the electronic device.

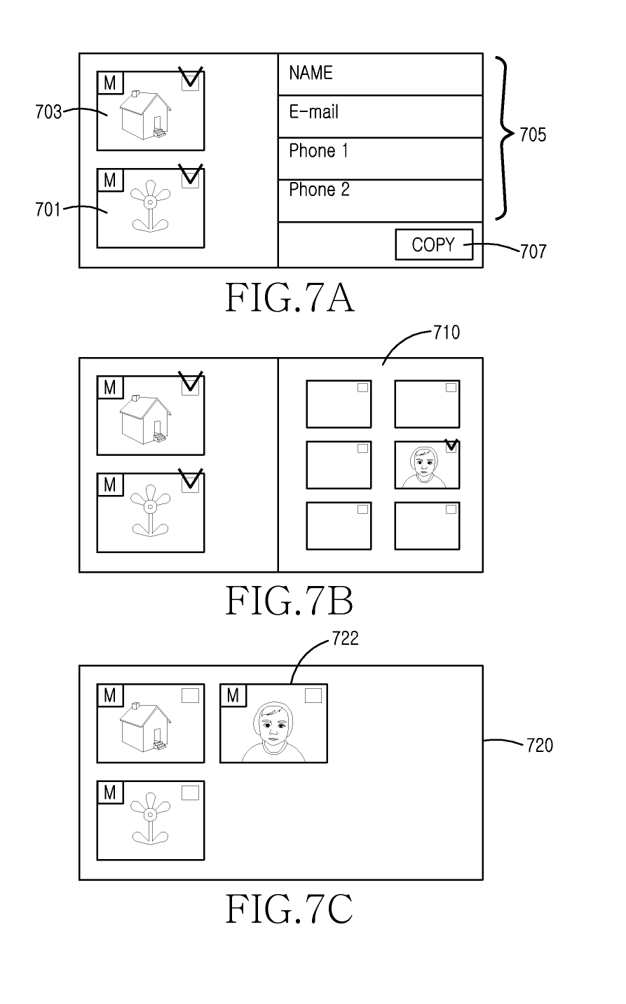

FIGS. 7A to 7C are diagrams illustrating examples of screens in a process for marking user information on data in an electronic device according to another embodiment of the present invention.

First, the electronic device displays a list of data onto which user information has been marked. This list is displayed in order apply information marked onto data to other data in the same way. The electronic device displays a list of data including marking information to apply to new data.

FIG. 7A illustrates a screen for selecting data onto which information to apply to other data has been marked, from among a list of data onto which user information has been marked.

When a user selects at least one data 703 and 703 from a displayed list, the electronic device displays information 705 of a user marked on the selected data and a menu 707 for copying this and applying this information to other data.

As shown in FIG. 7B, when the user selects a menu for marking the same user information to other data, the electronic device displays a list 710 of data to apply information marked onto the data selected by the user. The data displayed as in FIG. 7B may include data onto which user information has not been marked. Since another information may be double-marked (i.e., marked onto data onto which user information has been already marked), the data displayed in FIG. 7B may be data onto which user information has been marked.

As shown in FIG. 7C, when at least one data 722 is selected from the displayed list of data by the user, the electronic device marks the information of the data copied from FIG. 7A on the data selected in FIG. 7B, and manages, in screen 720 the data as data onto which user information has been marked.

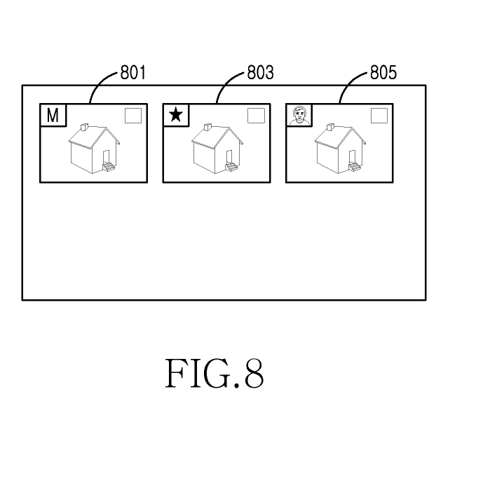

FIG. 8 is a diagram illustrating an example of a screen in a process for generating data onto which user information has been marked in an electronic device according to an embodiment of the present invention.

Referring to FIG. 8, according to an embodiment of the present invention, the electronic device marks user information onto data in order to simplify a data transmission process.

In the example of FIG. 8, marking user information includes setting an identifier of a user corresponding to a reception-side and a data transmission method no specific data. A user of the electronic device selects data onto which user information has been marked and simultaneously transmits the selected data to a reception-side user immediately.

Accordingly, the electronic device must use a method for discriminating and displaying general data and data on which user information has been marked.

For example, the electronic device adds a mark (ex: mark “M”) representing user information has been marked to a portion of an icon and a filename of first data 801.

In another example, the electronic device adds a favorite mark to a portion of an icon and a filename of second data 803. In this example, when data onto which user information has been marked operates in cooperation with a favorite function and a favorite function is executed, the marked data is displayed together with data registered in the favorite.

In still another example, the electronic device adds a photo of a user whose user information has been marked to a portion of an icon and a filename of third data 805. In this example, a user of the electronic device is able to easily determine a receiver to whom the user intends to be a recipient of relevant data.

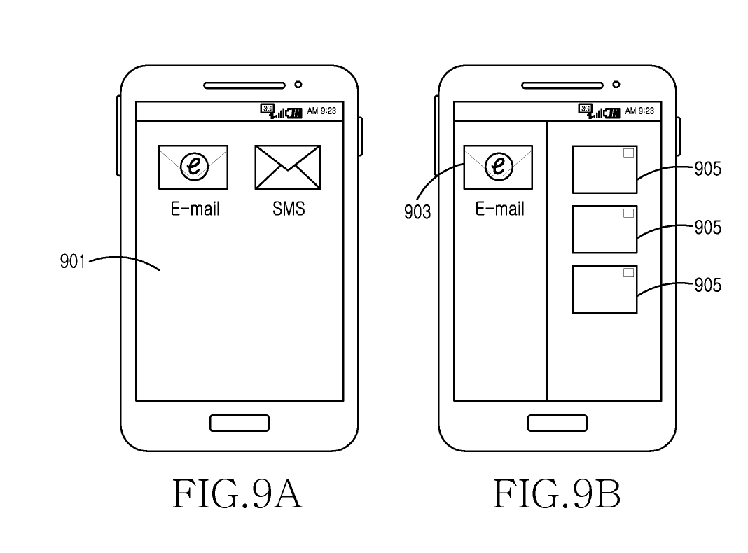

FIGS. 9A to 9B are diagrams illustrating examples of screen in a process for transmitting data in an electronic device according to another embodiment of the present invention.

Referring to FIG. 9A, the electronic device transmits specific data to a reception-side user using a transmission method marked onto data.

Reception-side information and a transmission method of data are determined via information of data selected by a user.

According to another embodiment of the present invention, when a function (i.e., a program) for transmitting data is selected, the electronic device according to an embodiment of the present invention provides a list of data that may be transmitted via the selected function.

For example, as described above, data selected by a user is transmitted to a reception-side user via an e-mail, a short message, etc.

For example, when an e-mail function that may be used to transmit data is selected by a user, a list of data onto which a transmission method corresponding to an e-mail has been marked may be displayed before or after the e-mail function is executed.

When a user selects at least one data from the displayed list, the electronic device executes an e-mail function to transmit the selected data to a reception-side user. The data includes the reception-side information, so that the electronic device automatically sets the reception-side information of the e-mail function.

FIG. 9A illustrates the electronic device displaying a list 901 of functions that are able to transmit data, and FIG. 9B illustrates the device displaying a list 905 of data that may be transmitted via a function 903 selected from the list 901.

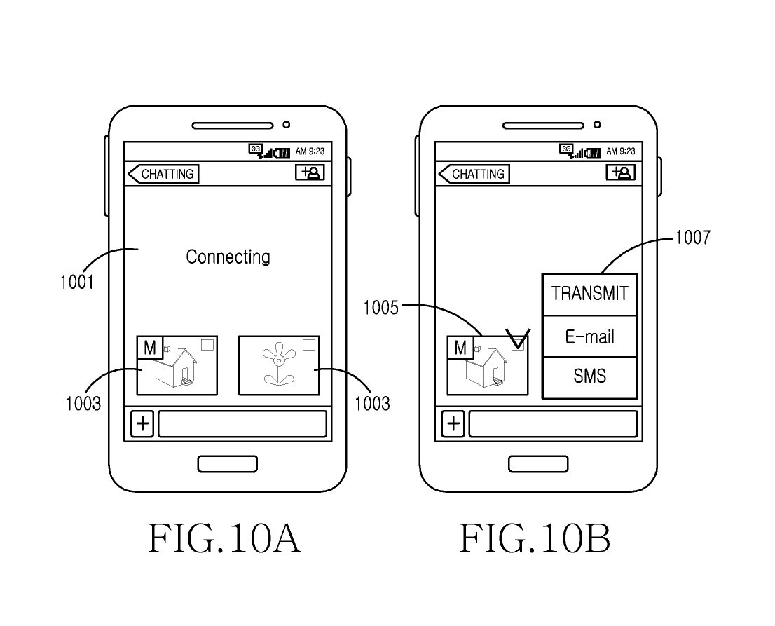

FIGS. 10A to 10B are diagrams illustrating examples of screens in a process for transmitting data in an electronic device according to still another embodiment of the present invention.

Referring to FIGS. 10A and 10B, the electronic device performs communication 1001 with a counterpart user, such as through a communication connection, a conversation via a messenger, and making an e-mail to be sent to a counterpart user.

An example of a process in which a user of the electronic device intends to transmit specific data to a counterpart user while performing a communication connection according to an embodiment of the present invention is described as follows.

In response to detecting a user's gesture for transmitting data during communication connection, the electronic device determines an identifier of a counterpart user who is connected for communication, and determines data onto which the determined identifier has been marked among data stored in advance.

Next, the electronic device displays a list 1003 of data onto which an identifier of a counterpart user has been marked, and processes transmission of data selected by a user from among the displayed data to the counterpart user.

When a user of the electronic device communicates with a counterpart user using a messenger, the electronic device will display data onto which an identifier of the counterpart user has been marked on a portion of a conversation screen. When the user of the electronic device composes an e-mail, the electronic device will display data onto which an identifier has been marked on a portion of a region where the user inputs mail content.

The electronic device also transmits data 1005 onto which the identifier has been marked to a counterpart user using a current communication method. The electronic device may display transmission methods 1007 before data transmission, in order to allow the data to be transmitted via other methods excluding the current communication method.

FIG. 10A illustrates a screen of the electronic device that has displayed data on which an identifier of a counterpart user has been marked during communication connection, and FIG. 10B illustrates a screen displaying a list of transmission methods for transmitting displayed data. Referring to FIG. 10B, in response to detecting an input of a user who selects “transmit” from among the displayed transmission methods, the electronic device transmits data using a data transmission function of the messenger. In response to detecting an input of the user who selects “e-mail”, the electronic device processes execution of an e-mail function with a messenger executed to transmit data.

In the manner described above, the electronic device transmits data to a counterpart user using a short message, WiFi, Bluetooth, etc.

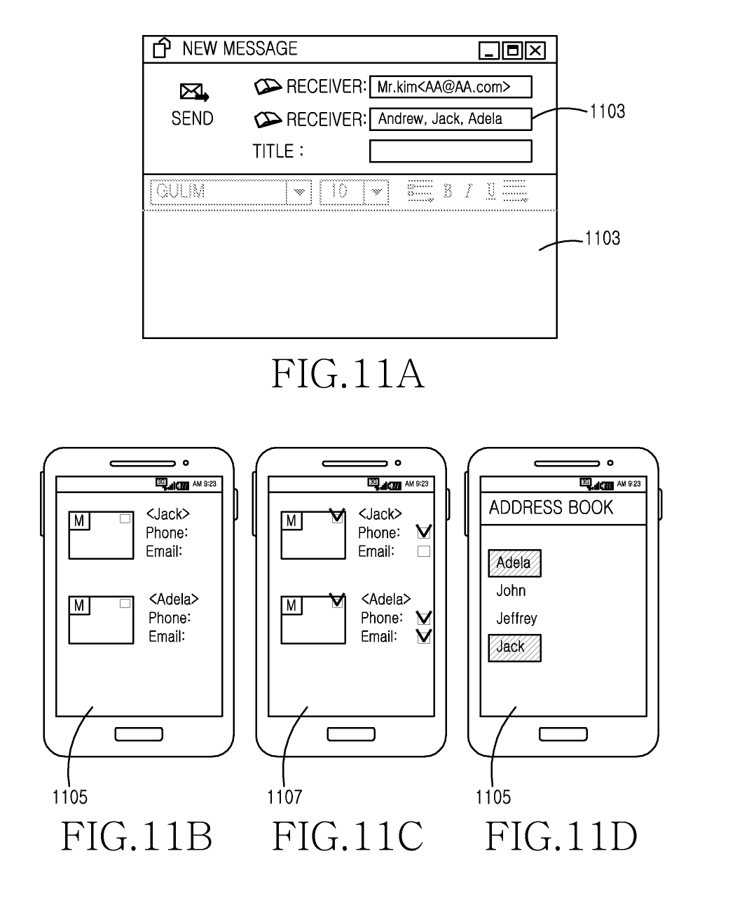

FIGS. 11A to 11D are diagrams illustrating examples of screens in a process for receiving data on which user information has been marked to update phonebook data in an electronic device according to an embodiment of the present invention.

Referring to FIGS. 11A to 11D, the electronic device receives data onto which user information has been marked.

The electronic device may delete marked user information before transmitting the data, or may alternatively transmit data without deleting marked user information according to a user's request.

In response to receiving data 1101 including marked information 1103 as shown in FIG. 11A, the electronic device displays information 1105 of a user marked onto received data, as illustrated in FIG. 11B.

User information marked onto the received data may include a user's phone number and name, and may additionally includes an e-mail address, a messenger ID, etc.

Accordingly, the electronic device that has received marked user information together with data simply adds the information to phonebook data.

FIG. 11C illustrates a screen for allowing a user to select an item to add to phonebook data among displayed user information. More specifically, FIG. 11C illustrates a situation 1107, in which a user of the electronic device intends to register only a phone number for a user Jack, but register both a phone number and an e-mail address for a user Adela.

Accordingly, user information selected by a user is added to phonebook data of the electronic device, as illustrated in FIG. 11D.

An apparatus and a method for managing data in an electronic device according to an embodiment of the present invention is able transmit data more conveniently than conventional methods by marking information of a reception-side onto data, managing the marked data, and directly transmitting the marked data to a counterpart user with a data list displayed.

Although the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention is not limited to the above-described embodiments but is defined by the appended claims and the equivalents thereof.

What is claimed is:

1. A method in an electronic device, the method comprising:
marking user information onto data and storing the marked data;
determining marked data to transmit from among data stored in advance, the data stored in advance including the stored marked data;
extracting user information from the determined marked data; and
setting the extracted user information as reception-side information of the determined marked data and transmitting the determined marked data according to the set reception-side information.

2. The method of claim 1, wherein marking the user information onto the data and storing the marked data comprises marking information of phonebook data onto the data.

3. The method of claim 1, wherein marking the user information onto the data and storing the marked data comprises applying information of a user marked onto a specific data onto another data.

4. The method of claim 1, wherein determining the marked data to transmit from among the marked data stored in advance comprises at least one of displaying a list of the marked data stored in advance and receiving a user selection of marked data from the displayed list, determining, from among at least one of data selected by a user, data onto which information of a counterpart user connected for communication has been marked, and determining data that is transmittable through use of an executed program.

5. The method of claim 1, wherein setting the extracted user information as the reception-side information of the determined marked data and transmitting the determined marked data comprises transmitting the extracted user information together with the determined marked data.

6. The method of claim 1, further comprising:
receiving data onto which user information has been marked from a counterpart user;
storing the received data; and
updating phonebook data using the user information marked onto the received data.

7. An electronic device comprising:
a display; and
at least one processor,
wherein the processor marks user information onto data and stores the marked data, determines marked data to transmit from among data stored in advance, the data stored in advance including the stored marked data, extracts user information from the determined marked data, sets the extracted user information as reception-side information of the determined marked data, control transmission of the determined marked data according to the set reception-side information.

8. The electronic device of claim 7, wherein, in marking the user information onto the data and storing the marked data, the processor marks information of phonebook data onto the data.

9. The electronic device of claim 7, wherein in marking the user information onto the data and storing the marked data, the processor applies information of a user marked onto specific data onto another data.

10. The electronic device of claim 7, wherein, in determining the marked data to transmit from among the marked data stored in advance, the processor performs at least one of:
processing display of a list of the marked data stored in advance and receives a user selection of marked data from the displayed list,
determining, from among at least one of data selected by a user, data onto which information of a counterpart user connected for communication has been marked, and
determining data that is transmittable through use of an executed program.

11. The electronic device of claim 7, wherein, in setting the extracted user information as the reception-side information of the determined marked data and transmitting the determined marked data, the processor processes transmission of the extracted user information marked on the data together with the data.

12. The electronic device of claim 7, wherein the processor processes receipt of data onto which user information has been marked from a counterpart user, storage of the received data, and an update of phonebook data using the user information marked onto the data.

13. A non-transitory computer-readable storage medium that records a program thereon,
wherein when executed by an electronic device, the program allows the electronic device to mark user information onto data and store the marked data, determine marked data to transmit from among data stored in advance including the stored marked data, extract user information from the determined marked data, set the extracted user information as reception-side information of the determined marked data, and transmit of the determined marked data according to the set reception-side information.
